(19) United States
(12) Patent Application Publication
(10) Pub. No.: US 2017/0212743 A1
(43) Pub. Date: Jul. 27, 2017

(54) SYSTEM AND METHOD FOR RELIABILITY, AVAILABILITY, AND SERVICEABILITY

(71) Applicant: INTERNATIONAL BUSINESS MACHINES CORPORATION, Armonk, NY (US)

(72) Inventors: GORDAN G. GREENLEE, ENDICOTT, NY (US); ROBERT S. MILLIGAN, ERLANGER, KY (US); CHRISTOPHER L. MOLLOY, RALEIGH, NC (US); CRAIG A. NYGARD, RESEARCH TRIANGLE PARK, NC (US); STEVEN A. WAITE, MILWAUKEE, WI (US)

(21) Appl. No.: 15/249,362

(22) Filed: Aug. 27, 2016

Related U.S. Application Data
(63) Continuation-in-part of application No. 15/004,156, filed on Jan. 22, 2016.

(51) Int. Cl. G06F 9/445

(52) U.S. Cl. CPC G06F 8/61; G06F 9/44505

(57) ABSTRACT

A system and method may include determining robustness of a target computer, gathering information regarding the target computer from a research engine, determining an order in which software packages are upgraded, dynamically adjusting the robustness of the target computer, returning data for a found component of the target computer, crawling the web looking for content related to a submission request, and updating data in a repository.

### CROSS-REFERENCE TO RELATED APPLICATIONS

This application is a continuation in part of application Ser. No. 15/004,156 filed Jan. 22, 2016.

### BACKGROUND OF THE INVENTION

The present invention generally relates to a method of upgrading patterns such as software. More particularly, the present invention relates to reducing time, risk, and errors related to upgrading patterns.

Cost of computer outages can be expensive. These outages may be increased if software is out of date.

As can be seen, there is a need for a system and method for keeping patterns current.

### SUMMARY OF THE INVENTION

In one aspect, a method may include a research engine determining robustness of a target computer based on software execution patterns and complexity of relationships between all software packages installed on the target computer; and evaluating whether to upgrade at least one of the software packages installed in the target computer to be current while maintaining or improving the determined robustness of the target computer, wherein the robustness of the target computer is determined based on details from a plurality of servers attached to the target computer, devices linked to the target computer, and storage devices linked to the target computer, electronic switch information linked to the target computer, bus adapter information linked to the target computer, device driver multi-path software information for the target computer, real-time social media information, currency of the target computer, and cost details for all software and hardware components on the target computer; wherein a data analysis and rules engine gathers all information regarding the target computer from the research engine; in response to evaluating that an upgrade to at least one of the software packages are needed, the research engine determining an order in which software packages should be upgraded while maintaining or improving the determined robustness of the target computer, wherein the robustness of the target computer is dynamically adjusted based on a plurality of datasets across websites, APIs, and social media platforms indicative of user feedback directed to at least one of the software packages installed on the target computer, wherein in response to the research engine being configured to only leverage existing data for a component of the target computer robustness, the research engine returns data for a found component of the target computer robustness to the data analysis and rules engine, wherein in response to the research engine being configured to leverage existing data and enrich it based on social media and web results, a data miner crawls the web looking for content related to a submission request and returns results to the research engine, wherein in response to relevant data being found by the data miner, an end user is notified and allowed to manually enter data, and a repository containing the relevant data is updated and sent back to the research engine, and the research engine sends the updated data to the data analysis and rules engine, wherein the research engine continues to update the repository thereby supporting future results for the data and analysis engine.

These and other features, aspects and advantages of the present invention will become better understood with reference to the following drawings, description and claims.

### BRIEF DESCRIPTION OF THE DRAWINGS

FIG. 1 illustrates a method of updating software; and

FIG. 2 illustrates a system that can be used to implement the method of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a method of upgrading patterns such as software on a computer.

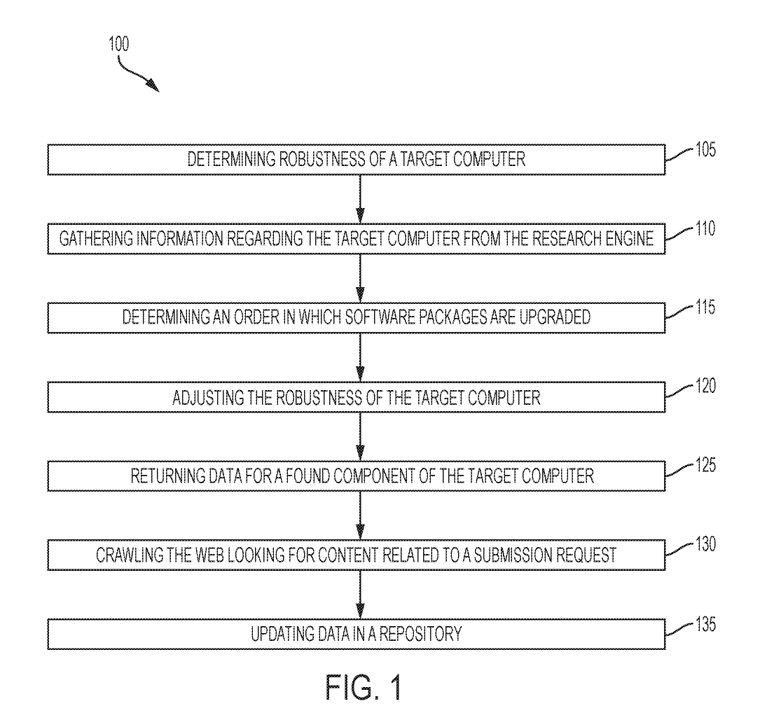

In FIG. 1, a method 100 may include a step 105 of determining robustness of a target computer. A step 110 may include gathering information regarding the target computer from a research engine. A step 115 may include determining an order in which software packages are upgraded. A step 120 may include adjusting the robustness of the target computer. A step 125 may include returning data for a found component of the target computer. A step 130 may include crawling the web looking for content related to a submission request. A step 135 may include updating data in a repository.

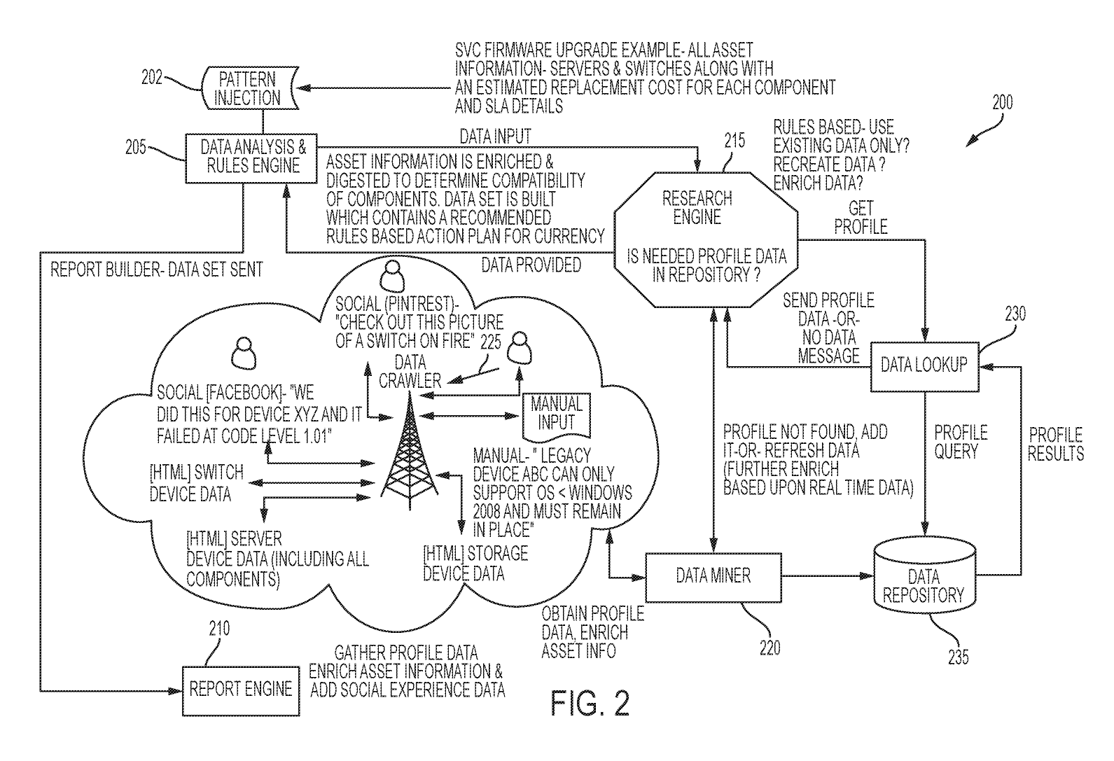

In FIG. 2, a Data Analytics and Rules Engine 205 can digest all input data (holistically) and create output data sets based upon needs of an injected pattern input 202. This engine 205 can work directly with a Research Engine 215 to obtained data for needed analytics. The Research Engine 215 can determine if request information exists in the repository, and if not, can take steps necessary to obtain the needed data. When data is needed it can be obtained from a variety of sources to build a profile—HTML, API, Social (Facebook/Tweeter/etc.), and manual input (for components not discoverable by other means). Data can be retained for future pattern remediation research/needs. A Data Look-up module 230 can provide data to the Research Engine 215 and can manage profile information leveraging in a Data Repository 235 as a data warehouse. A Data Miner 220 can work via a Data Crawler 225, and can provide data to the Research Engine 215 as a result of searching a variety of sources (via a Data Crawler Process)—HTML, API, Social (Facebook/Tweeter/etc.), and manual input (for components not discoverable by other means). The Data Crawler Process within the Data Crawler 225 can support Data Miner 220 efforts by directly searching a variety of sources on the web—HTML, API, Social (Facebook/Tweeter/etc.), and manual input (for components not discoverable by other means). The Data Repository 235 may be a Data warehouse 235 and may contain the needed profile information uncovered from Data Mining events. A Report Engine 210 can use the data assembled by Data Analytics and Rules Engine 205, and the Report engine can create the needed remediation output.

In an embodiment, the method 100 may improve RAS (Reliability, Availability, and Serviceability) by gathering input and using a rules based research engine with data look-up. This engine may create and maintain a profile for each injected pattern, which may be used as an additional input to the engine to determine what changes need to be made so RAS is improved. Analytics may be used to digest multiple sources of input and weigh them against an injected pattern to create a roadmap for currency remediation. This roadmap can identify the steps necessary to upgrade each pattern component needed to improve a customer's risk posture and an expected cost for the remediation.

RAS can leverage analytics based upon a rules set of industry best practices and customer specific requirements. RAS can leverage social media (as a feed) to understand impact based upon other's real time results from various social streams such as Facebook and Twitter and help the end user understand the right recommended level of currency as part of the process to ensure success—perhaps the most current upgrade/service pack/solution may not be ready to support a complex pattern. One way to assess this may be via real-time analysis of results from others. RAS may not install software, yet it can create a remediation plan with the steps necessary for currency for the injected software pattern along with an estimated cost, based upon input. RAS can help with confirmation of steps needed to achieve a specific level of software certification to avoid a violation.

In an embodiment, the method 100 can take multiple feeds/sources into account and continue to evolve in order to improve future pattern remediation outcome based upon customer needs. Patterns can be examined holistically to look at complexity between similar components to make certain a remediation for one application component does not adversely impact another. Injected patterns can be application patterns (multiple applications that make up an ecosystem)—such as highly complex solutions. Social media inputs can allow for gathering of real-time input for the components to support the injected application pattern as leverage to improve success factors for the generated deliverable. Data inputs may be obtained from many sources for a holistic view-HTML, API, Social (Facebook/Tweeter/etc.), and manual input (for components not discoverable by other internet based means). Customer differentiators can be included. Business drivers can be taken as a factor into the rules engine.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer program product, the computer program product comprising a computer readable storage medium having program instructions embodied therewith, the program instructions executable by a computer to cause the computer to:
determine robustness of a target computer, using a research engine, based on software execution patterns and complexity of relationships between all software packages installed on the target computer; and evaluate whether to upgrade at least one of the software packages installed in the target computer to be current while maintaining or improving the determined robustness of the target computer,
wherein the robustness of the target computer is determined based on details from a plurality of servers attached to the target computer, devices linked to the target computer, and storage devices linked to the target computer, electronic switch information linked to the target computer, bus adapter information linked to the target computer, device driver multi-path software information for the target computer, real-time social media information, currency of the target computer, and cost details for all software and hardware components on the target computer;
wherein a data analysis and rules engine gathers all information regarding the target computer from the research engine;
in response to evaluating that an upgrade to at least one of the software packages are needed, determine, by the research engine, an order in which software packages should be upgraded while maintaining or improving the determined robustness of the target computer,
wherein the robustness of the target computer is dynamically adjusted based on a plurality of datasets across websites, APIs, and social media platforms indicative of user feedback directed to at least one of the software packages installed on the target computer,
wherein in response to the research engine being configured to only leverage existing data for a component of the target computer robustness, the research engine returns data for a found component of the target computer robustness to the data analysis and rules engine,
wherein in response to the research engine being configured to leverage existing data and enrich it based on social media and web results, a data miner crawls the web looking for content related to a submission request and returns results to the research engine,
wherein in response to relevant data being found by the data miner, an end user is notified and allowed to manually enter data, and a repository containing the relevant data is updated and sent back to the research engine, and the research engine sends the updated data to the data analysis and rules engine,
wherein the research engine continues to update the repository thereby supporting future results for the data and analysis engine.
